(19) United States
(12) Patent Application Publication
(10) Pub. No.: US 2015/0079339 A1
(43) Pub. Date: Mar. 19, 2015

(54) LAMINATED FABRIC CONSTRUCTION WITH HEAT ACTIVATED POLYURETHANEUREA COMPOSITIONS

(71) Applicant: INVISTA North America S.à r.l., Wilmington, DE (US)

(72) Inventors: Carmen A. COVELLI, Chadds Ford, PA (US); Hong Liu, Waynesboro, VA (US); Douglas K. Farmer, Greensboro, NC (US)

(73) Assignee: INVISTA North America S.à r.l., Wilmington, DE (US)

(21) Appl. No.: 14/552,060

(22) Filed: Nov. 24, 2014

Related U.S. Application Data
(63) Continuation of application No. 11/745,668, filed on May 8, 2007, now abandoned.
Application No. 11/745,668 is a continuation-in-part of application No. 11/351,967, filed on Feb. 10, 2006, now abandoned.
Application No. 11/351,967 is a continuation-in-part of application No. 11/300,229, filed on Dec. 13, 2005, now abandoned.
Application No. 11/300,229 is a continuation-in-part of application No. 11/253,927, filed on Oct. 19, 2005, now abandoned.
Application No. 11/253,927 is a continuation-in-part of application No. 11/056,067, filed on Feb. 11, 2005, now Pat. No. 7,240,371.

(51) Int. Cl. B32B 3/26; B32B 5/26; B32B 5/32; B32B 27/06; B32B 7/12; B32B 27/12; B32B 27/40; B32B 5/22; B32B 5/24

(52) U.S. Cl. CPC B32B 3/266; B32B 5/22; B32B 5/26; B32B 5/32; B32B 5/245; B32B 7/12; B32B 27/12; B32B 27/40; B32B 27/065; B32B 2250/03; B32B 2437/00; B32B 2305/022
USPC 428/137; 428/221; 428/304.4; 428/316.6; 428/319.7

(57) ABSTRACT

Articles comprising multiple layers are included. The multiple layer articles may include fabrics or foams in combination with a polyurethaneurea composition such as a film or an aqueous dispersion.

### CROSS-REFERENCE TO RELATED APPLICATIONS

This application is a continuation of U.S. application Ser. No. 11/745,668, filed on May 8, 2007, which is a continuation-in-part of U.S. application Ser. No. 11/351,967 filed on Feb. 10, 2006, which is a continuation-in-part of U.S. application Ser. No. 11/300,229 filed on De. 13, 2005, which is a continuation-in-part of U.S. application Ser. No. 11/253,927 filed on Oct. 19, 2005, which is a continuation-in-part of U.S. application Ser. No. 11/056,067 filed on Feb. 11, 2005, all of which are incorporated herein by reference.

### BACKGROUND OF THE INVENTION

1. Field of the Invention

The present invention relates to articles including a multiple layer construction. The layers include fabric and/or polyurethane foam in combination with a polyurethaneurea composition.

2. Summary of Related Technology

Polyurethanes (including polyurethaneureas) can be used as adhesives for various substrates, including textile fabrics. Typically, such polyurethanes are either fully formed non-reactive polymers or reactive isocyanate-terminated prepolymers. Such reactive polyurethane adhesives often require extended curing time to develop adequate bonding strength, which can be a disadvantage in manufacturing processes. In addition, the isocyanate groups of the polyurethanes are known to be sensitive to moisture, which limits the storage stability and reduces the shelf life of the product incorporating such polyurethanes.

Typically, such polymers, when fully formed, are either dissolved in a solvent (solvent borne), dispersed in water (water borne), or processed as thermoplastic solid materials (hot melt). Notably, solvent-based adhesives face ever-tightening health and environmental legislation aimed at reducing volatile organic compound (VOC) and hazardous air pollutant (HAP) emissions. Accordingly, alternatives to conventional solvent-based products are may be needed in the future.

Hot-melt adhesives, although environmentally safe and easily applied as films, generally have high set and poor recovery when subject to repeated stretch cycles. Therefore, adhesives that overcome the performance concerns of hot-melt adhesives are needed. Desirably, such adhesives will also provide other benefits to the fabric such as flexibility, shape retention and air permeability compared to conventional thermoplastic polyurethane and hot-melt adhesives.

### SUMMARY OF THE INVENTION

Some embodiments provide a multi-layer article including at least two layers and a polyurethaneurea composition. The polyurethaneurea composition may form one of the layers, for example, as a polyurethaneurea composition on a substrate. The polyurethaneurea composition may be in any suitable form such as a film or dispersion. The polyurethaneurea composition may be placed adjacent to or between the layers and also may provide adhesion, moldability, shape retention, and flexibility properties for the article.

Some embodiments provide an article including multiple layers (multi-layer) which has been pressed, laminated and/or molded. This article includes at least two layers where one of the layers is a polyurethaneurea composition in the form of a film or dispersion.

A further embodiment provides an article including at least one fabric layer and at least one polyurethaneurea composition selected from the group consisting of films, dispersions, and combinations thereof.

### DETAILED DESCRIPTION OF THE INVENTION

As used herein, the term “porous” refers to a substrate that includes voids or holes in the surface or at any point within or through the thickness of the substrate or to any material of which the articles of the present invention may come into contact.

As used herein, the term “pressing” or “pressed” refers to an article that has been subjected to heat and/or pressure to provide a substantially planar structure.

As used herein, the term “foam” refers to any suitable foam that may be used in fabric construction such as polyurethane foam.

As used herein, the term “dispersion” refers to a system in which the disperse phase consists of finely divided particles, and the continuous phase can be a liquid, solid or gas.

As used herein, the term “aqueous polyurethane dispersion” refers to a composition containing at least a polyurethane or polyurethane urea polymer or prepolymer (such as the polyurethane prepolymer described herein), optionally including a solvent, that has been dispersed in an aqueous medium, such as water, including de-ionized water.

As used herein, the term “solvent,” unless otherwise indicated, refers to a non-aqueous medium, wherein the non-aqueous medium includes organic solvents, including volatile organic solvents (such as acetone) and somewhat less volatile organic solvents (such as MEK, or NMP).

As used herein, the term “solvent-free” or “solvent-free system” refers to a composition or dispersion wherein the bulk of the composition or dispersed components has not been dissolved or dispersed in a solvent.

As used herein, the term “article” refers to an article which comprises a dispersion or shaped article and a substrate, for example a textile fabric, which may or may not have at least one elastic property, in part, due to the application of a dispersion or shaped article as described herein. The article may be in any suitable configuration such as one-dimensional, two-dimensional and/or three-dimensional.

As used herein, the term “fabric” refers to a knitted, woven or nonwoven material. The knitted fabric may be flat knit, circular knit, warp knit, narrow elastic, and lace. The woven fabric may be of any construction, for example sateen, twill, plain weave, oxford weave, basket weave, and narrow elastic. The nonwoven material may be meltblown, spun bonded, wet-laid, carded fiber-based staple webs, and the like.

As used herein, the term “substrate” refers to any material to which the articles of the present invention may come into contact. A substrate can be substantially one dimensional as is a fiber, two dimensional as in a planar sheet, or a three dimensional article or a bumpy sheet. A planar sheet for example may comprise textile fabric, paper, flocked article, and web. A three dimensional article for example may comprise leather and foam. Other substrates may comprise wood, paper, plastic, metal, and composites such as concrete, asphalt, gymnasium flooring, and plastic chips.

As used herein, the term “hard yarn” refers to a yarn which is substantially non-elastic.

As used herein, the term “molded” article refers to a result by which the shape of an article or shaped article is changed in response to application of heat and/or pressure.

As used herein, the term “derived from” refers to forming a substance out of another object. For example, a film may be derived from a dispersion which can be dried.

As used herein, the term “modulus” refers to a ratio of the stress on an item expressed in force per unit linear density or area.

In some embodiments are multiple layer articles which include at least one layer of a polyurethaneurea composition in the form of a film or dispersion. These articles have at least two layers including at least one polyurethaneurea composition. The polyurethaneurea composition may form one of the layers, for example, as a polyurethaneurea composition on a substrate. The polyurethaneurea composition may be in any suitable form such as a film or dispersion. The polyurethaneurea composition may be placed adjacent to or between the layers and also may provide stretch and recovery, increased elastic modulus, adhesion, moldability, shape retention, and flexibility properties for the article. These articles may be formed into fabrics and/or garments.

A variety of different polyurethaneurea compositions are useful with the films and dispersions of some embodiments. For example, the films of the some embodiments may be cast from a solution, an aqueous dispersion, or a substantially solvent free aqueous dispersion. Many such solutions or dispersions are known in the art. For example, a polyurethaneurea solution such as a spinning solution from a commercial spandex production line may be used to cast a film, according to some embodiments of the present invention. Specific examples of aqueous dispersions and films cast from them which are useful with the present invention are described hereinbelow.

In an embodiment where the article includes a multiple layer article including three or more layers where one layer is a film, the film may be an intermediate layer between two fabric layers, between two foam layers, between a fabric layer and a foam layer, or adjacent to a foam layer which is adjacent to a fabric layer. Combinations of these fabric/foam/film arrangements are also contemplated. For example, the article may include, in order, a fabric layer, a foam layer, a film layer, a foam layer, and a fabric layer. This article includes two separate fabric layers, two separate foam layers and a film layer. In any of these embodiments, the polyurethaneurea film may be replaced with a polyurethaneurea dispersion. Therefore, the article may include one or more polyurethaneurea film and one or more polyurethaneurea dispersion layer.

In another embodiment, a single layer of a fabric or foam may be folded to form two or more layers of the multiple layer article with a polyurethaneurea film or dispersion as an intermediate layer. In this embodiment, the article may then also be molded or pressed to a desired shape, such as for a body shaping garment. Where a tape is placed at the point of folding, the tape may provide additional stretch recovery power, such as at a hem or for a body shaping garment, to provide additional support. This is also useful in a garment such as an underbust bra where the film/tape placement may provide increased wall strength or rigidity and may keep the garment from rolling at the edge.

In an embodiment that includes two or more layers, the polyurethaneurea composition may form the external layer. Including the polyurethaneurea composition on an external surface forms many advantageous functions. For example, the polyurethaneurea composition may provide an anchor or area of increased friction to reduce the relative movement between the article including the polyurethaneurea composition and an external substrate. This is particularly useful when the article is an undergarment including a skin-contacting surface (where the wearer's skin is the substrate). Alternatively, the substrate may be outer clothing which is in contact with the polyurethaneurea composition of the inventive article. Where the substrate is outer clothing of a wearer and the article is worn as an undergarment, the article prevents or reduces the relative movement of the outer garment. In addition, an outer garment (e.g. a dress) may include a polyurethaneurea composition to maintain the relative placement of an inner garment (e.g. a slip).

After the layers of fabric, foam, and the polyurethaneurea composition have been selected, they may subsequently be adhered through pressing or molding to form flat or shaped articles. The processes to prepare the pressed and molded articles of some embodiments include the use of pressure and heat as necessary. For example, heat may be applied at about 150° C. to about 200° C. or about 180° C. to about 190° C., including about 185° C. for a sufficient time to achieve a molded article. Suitable times for application of heat include, but are not limited to, from about 30 sec to about 360 sec including from about 45 sec to about 120 sec. Bonding may be effected by any known method, including but not limited to, microwave, infrared, conduction, ultrasonic, pressure application over time (i.e. clamping) and combinations thereof.

Due the application of heat and pressure to the articles including polyurethaneurea films or dispersion and given that films and fabrics are themselves porous materials, it is recognized that the film or dispersion may partially or completely impregnate the fabric or foam of the article. For example, the polyurethaneurea composition may form a layer which is partially separate from the surrounding layers, or may be completely transferred to the surrounding layer or layers to form an integrated article without a distinguishably separate polyurethaneurea composition layer.

One application of the multi-layer articles of the present invention is body-shaping garments such as brassieres (especially in cups or wings) and men's undergarments. These articles can provide the desirable features of comfort, body shaping and support while still providing comfort, breathability, air permeability, moisture/vapor transport, wicking, and combinations thereof. In the articles of some embodiments of the present invention, the layers may take on predetermined shapes and may be arranged in predetermined orientations relative to each other in the design of a molded or shaped article such as the cups of a brassiere construction. The layers of these fabrics may be used either alone or in combination with other materials that are sewn, glued or otherwise applied to the fabrics.

In some embodiments there is a system for the construction of a body-shaping garment with integrated shaping ability provided by the fabric. This system of construction may be used in a variety of different garment constructions such as activewear, sportswear, men's and women's intimate apparel such as bras, underwear, panties, shaping garments, legwear and hosiery such as pantyhose, ready-to-wear garments such as denim jeans, camisoles, tailored shirts, and pants among others. This construction may be applied to any formable body area. While many advantages of the fabric constructions are included, it is further recognized that the utility is not limited to garments, but also finds applicability with any shapeable or formable medium, including cushions for furniture which are also subject to movement and potential slipping of a fabric in contact with the shapeable area.

In order to add additional support and other features, the polyurethaneurea composition may be added to different areas of the article. For example, when a film is used, it may either extend through the entire area of the article or to a selected portion to provide different benefits. For example, a brassiere may include a layered fabric of some embodiments in the cup portion. In the brassiere cup, it can be useful to use a portion of film in the lower portion of the cup for support, in a central portion of the cup for modesty, in the side portion for shaping, or in specific areas for embellishment or decoration.

Reducing the amount of film in a multi-layer fabric to meet the needs of a fabric may also increase the air permeability of the fabric. As is shown in the examples, the polyurethaneurea compositions derived from the aqueous dispersion described herein provided greater air permeability than those derived from polyurethaneurea solutions. The films cast from the aqueous dispersions also performed better with respect to air permeability in comparison to commercially available thermoplastic polyurethane (TPU) films available from Bemis. Air permeability may also be increased by altering the film to make it porous or to become porous (i.e. “latent” breathability) or by perforating the film.

Another advantage of the films cast from the aqueous dispersions of some embodiments is with respect to the feel or tactility of the films. They provide a softer feel compared to silicone rubber or the commercially available TPU films while maintaining the desired friction to reduce movement that is a further advantage for skin contact applications. Also lower bending modulus gives better drape and fabric hand.

The polyurethaneurea compositions provide additional benefits especially as compared to commercially available thermoplastic polyurethaneurea compositions, when used in a garment. These benefits include shape retention, shaping ability, adhesion, maintaining a fraction of the substrates, moisture management, and vapor permeability.

The polyurethaneurea compositions may be added in other constructions depending on the desired function which may be a visual aesthetic. The polyurethaneurea films or dispersions may be added to an article, fabric or garment to be molded into a design, to adhere embellishments such as decorative fabrics and glitter, in the form of a label or logo, and combinations thereof.

Depending on the desired effect of the polyurethaneurea composition when applied as a film or dispersion from the aqueous dispersion described herein, the weight average molecular weight of the polymer in the film may vary from about 40,000 to about 150,000, including from about 100,000 to about 150,000 and about 120,000 to about 140,000.

In some embodiments, the polyurethaneurea composition may act as an adhesive to attach two or more layers of fabric or foam, or to attach a layer of fabric to foam. One suitable method for accomplishing this is to apply a dispersion to a layer by any suitable method. Methods for applying the dispersions of some embodiments include spraying, kissing, printing, brushing, dipping, padding, dispensing, metering, painting, and combinations thereof. This may be followed by application of heat and/or pressure.

Other adhesives may be included in the multiple layer articles of some embodiments of the invention. Examples of adhesives include thermoset or thermoplastic adhesives, pressure sensitive adhesives, hot melt adhesives, and combinations thereof. The adhesive may be used to adhere the different layers and may be applied to any of the fabric, foam or polyurethaneurea films or dispersion. Moreover, the polyurethaneurea aqueous dispersions may also be used as an adhesive to adhere more than one layer of any fabric, foam or polyurethaneurea film as described in some embodiments.

As described above, there are a variety of fabric constructions that are useful for the articles of the present invention. Furthermore, the polyurethane composition may be either a film or a dispersion in any of these embodiments. In addition, the polyurethaneurea composition may provide structural properties, flexibility, adhesion, or any combination of these. The order of layer arrangement may be (1) fabric layer, foam layer, polyurethaneurea composition layer; (2) fabric layer, foam layer, polyurethaneurea composition layer, foam layer, fabric layer; (3) fabric layer, polyurethaneurea composition layer, fabric layer; (4) foam layer, polyurethaneurea layer, foam layer; (5) foam layer, polyurethaneurea composition layer; (6) fabric layer, polyurethaneurea layer; or any combination of these which may be combined to achieve more layers in the fabric construction. An adhesive may be included to adhere any of the layers, including wherein the polyurethaneurea composition is the adhesive.

A variety of different fibers and yarns may be used with the fabrics of some embodiments. These include cotton, wool, acrylic, polyamide (nylon), polyester, spandex, regenerated cellulose, rubber (natural or synthetic), bamboo, silk, soy or combinations thereof.

Aqueous polyurethane dispersions useful in some embodiments of the invention are provided from particular urethane prepolymers, which are described below in more detail.

Urethane prepolymers, or capped glycols, can generally be conceptualized as the reaction product of a polyol, a polyisocyanate, and a compound capable of salt-forming upon neutralization, before the prepolymer is dispersed in water and is chain-extended. Such prepolymers can typically be made in one or more steps, with or without solvents. Depending on whether the prepolymer is dissolved in a less volatile solvent (such as MEK, or NMP) which will remain in the dispersion; dissolved in a volatile solvent such as acetone, which can be later removed; or is dispersed in water without any solvent; the dispersion process can be classified in practice as the solvent process, acetone process, or prepolymer mixing process. The prepolymer mixing process has environmental and economical advantages, and therefore is also useful as the basic process for making the aqueous dispersions in the present invention.

In the prepolymer mixing process, it is important that the viscosity of the prepolymer is adequately low enough, without dilution by a solvent, to be transported and dispersed in water. The present invention in one embodiment, relates to polyurethane dispersions derived from such a prepolymer, which meet this viscosity requirement and do not have any organic solvent in the prepolymer or in the dispersion. In accordance with the invention, the prepolymer is the reaction product of a polyol (a), a diisocyanate (b) and a diol compound (c). However, prepolymers including an organic solvent are also contemplated.

The present invention can provide stable, aqueous polyurethane dispersions, which can be processed and applied directly as adhesive materials (i.e., without the need of any additional adhesive materials) for coating, bonding, and lamination to substrates by conventional techniques. Aqueous polyurethane dispersions falling within the scope of the present invention may be provided with or without the use of volatile organic materials; with acceptable curing time in production; and with good adhesion strength, heat resistance, and stretch/recovery properties in finished products and in practical applications.

The present invention can also provide shaped articles which may or may not be adhesive that can be coated on a release paper, whereby aqueous dispersions of the invention can be used for bonding and lamination to substrates including textile fabrics. The adhesion can be activated by applying heat and/or pressure onto a substrate and the adhesive film with a residence time of less than one minute, for example, from about 15 seconds to about 60 seconds. The thus bonded articles have good stretch/recovery properties and are expected to be durable in normal wear and wash cycles.

Polyol components suitable as a starting material for preparing urethane prepolymers, according to the invention, are polyether glycols, polycarbonate glycols, and polyester glycols of number average molecular weight of about 600 to about 3,500.

Examples of polyether polyols that can be used include those glycols with two or more hydroxy groups, from ring-opening polymerization and/or copolymerization of ethylene oxide, propylene oxide, trimethylene oxide, tetrahydrofuran, and 3-methyltetrahydrofuran, or from condensation polymerization of a polyhydric alcohol, preferably a diol or diol mixtures, with less than 12 carbon atoms in each molecule, such as ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear, bifunctional polyether polyol is preferred, and a poly(tetramethylene ether) glycol of molecular weight of about 1,700 to about 2,100, such as Terathane® 1800 (Invista) with a functionality of 2, is particularly preferred in the present invention.

Examples of polyester polyols that can be used include those ester glycols with two or more hydroxy groups, produced by condensation polymerization of aliphatic polycarboxylic acids and polyols, or their mixtures, of low molecular weights with no more than 12 carbon atoms in each molecule. Examples of suitable polycarboxylic acids are malonic acid, succinic acid, glutaric acid, adipic acid, pimelic acid, suberic acid, azelaic acid, sebacic acid, undecanedicarboxylic acid, and dodecanedicarboxylic acid. Examples of suitable polyols for preparing the polyester polyols are ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear bifunctional polyester polyol with a melting temperature of about 5° C. to about 50° C. is preferred.

Examples of polycarbonate polyols that can be used include those carbonate glycols with two or more hydroxy groups, produced by condensation polymerization of phosgene, chloroformic acid ester, dialkyl carbonate or diallyl carbonate and aliphatic polyols, or their mixtures, of low molecular weights with no more than 12 carbon atoms in each molecule. Examples of suitable polyols for preparing the polycarbonate polyols are diethylene glycol, 1,3-propanediol, 1,4-butanediol, 1,5-pentanediol, 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear, bifunctional polycarbonate polyol with a melting temperature of about 5° C. to about 50° C. is preferred.

The polyisocyanate component (b), suitable as another starting material for making urethane prepolymers according to the invention, can be an isomer mixture of diphenylmethane diisocyanate (MDI) containing 4,4′-methylene bis(phenyl isocyanate) and 2,4′-methylene bis(phenyl isocyanate) in the range of 4,4′-MDI to 2,4′-MDI isomer ratios of between about 65:35 to about 35:65, preferably in the range of about 55:45 to about 45:55 and more preferably at about 50:50. Examples of suitable polyisocyanate components include Mondur® ML (Bayer), Lupranate® MI (BASF), and Isonate® 50 O,P′ (Dow Chemical).

Diol compounds (c), suitable as further starting materials for preparing urethane prepolymers according to the invention, include at least one diol compound with: (i) two hydroxy groups capable of reacting with the polyisocyanates b); and (ii) at least one carboxylic acid group capable of forming salt upon neutralization and incapable of reacting with the polyisocyanates (b). Typical examples of diol compounds (c) having a carboxylic acid group, include 2,2-dimethylopropionic acid (DMPA), 2,2-dimethylobutanoic acid, 2,2-dimethylovaleric acid, and DMPA initiated caprolactones such as CAPA® HC 1060 (Solvay). DMPA is preferred in the present invention.

The prepolymer can be prepared by mixing starting materials (a), (b), and (c) together in one step and by reacting at temperatures of about 50° C. to about 100° C. for adequate time until all hydroxy groups are essentially consumed and a desired % NCO of the isocyanate group is achieved. Alternatively, this prepolymer can be made in two steps by first reacting starting material (a) with excess (b), followed by reacting with component (c) until a final desired % NCO of the prepolymer is achieved. For example, the % NCO may range from about 1.3 to about 6.5, such as from about 1.8 to about 2.6. Significantly, no organic solvent is added to or mixed with the starting materials before, during or after the reaction. Optionally, a catalyst may be used to facilitate the prepolymer formation.

In an embodiment of the present invention, the prepolymer comprises components (a), (b), and (c), which are combined together and provided in the following ranges of weight percentages, based on the total weight of the prepolymer:
about 34% to about 89% of component (a);
about 59% to about 10% of component (b); and
about 7.0% to about 1.0% of component (c).

In another embodiment of present invention, the prepolymer comprises Terathane® 1800 polyether glycol as component (a), Mondur® ML diisocyanate as component (b), and 2,2-dimethylopropionic acid (DMPA) as component (c). Within such embodiments, these components may, for example, be present in the following ranges of weight percentages, based on the total weight of the prepolymer:

a) Terathane® 1800 polyether glycol: about 61% to about 80%;

b) Mondur® ML diisocyanate: about 35% to about 18%; and

c) 2,2-dimethylopropionic acid (DMPA): about 4.0% to about 2.0%.

The prepolymer prepared from components (a), (b) and (c) should have a bulk viscosity (without any solvent present) below about 6,000 poises, such as below about 4,500 poises, measured by the falling ball method at 40° C. This prepolymer, containing carboxylic acid groups along the polymer chains, can be dispersed with a high-speed disperser into a de-ionized water medium that comprises: at least one neutralizing agent (d), to form an ionic salt with the acid; at least one surface active agent (ionic and/or non-ionic dispersant or surfactant); and, optionally, at least one diamine chain extension component (f). Alternatively, the neutralizing agent can be mixed with the prepolymer before being dispersed into the water medium. At least one antifoam and/or defoam agent and preferably at least one rheological modifier can be added to the water medium before, during, or after the prepolymer is dispersed.

Examples of suitable neutralizing agents (d) to convert the acid groups to salt groups include: tertiary amines (such as triethylamine, N,N-diethylmethylamine, N-methylmorpholine, N,N-diisopropylethylamine, and triethanolamine) and alkali metal hydroxides (such as lithium, sodium and potassium hydroxides). Primary and/or secondary amines may be also used as the neutralizing agent for the acid groups. The degrees of neutralization are generally between about 60% to about 140%, for example, in the range of about 80% to about 120% of the acid groups.

Examples of suitable diamine chain extenders (f) include: 1,2-ethylenediamine, 1,4-butanediamine, 1,6-hexamethylenediamine, 1,12-dodecanediamine, 1,2-propanediamine, 2-methyl-1,5-pentanediamine, 1,2-cyclohexanediamine, 1,4-cyclohexanediamine, 4,4′-methylene-bis(cyclohexylamine), isophorone diamine, 2,2-dimethyl-1,3-propanediamine, meta-tetramethylxylenediamine, and Jeffamine® (Texaco) of molecular weight less than 500.

Examples of suitable surface active agents include: anionic, cationic, or nonionic dispersants or surfactants, such as sodium dodecyl sulfate, sodium dodecylbenzenesulfonate, ethoxylated nonylphenols, and lauryl pyridinium bromide.

Examples of suitable antifoaming or deforming or foam controlling agents include: Additive 65 and Additive 62 (silicone based additives from Dow Corning), FoamStar® I 300 (a mineral oil based, silicone free defoamer from Cognis) and Surfynol™ DF 110L (a high molecular weight acetylenic glycol non-ionic surfactant from Air Products & Chemicals).

Examples of suitable rheological modifiers include: hydrophobically-modified ethoxylate urethanes (HEUR), hydrophobically-modified alkali swellable emulsions (HASE), and hydrophobically-modified hydroxy-ethyl cellulose (HMHEC).

At least one monofunctional dialkyl amine compound (e), as the blocking agent for isocyanate groups, is added to the water medium during or after the prepolymer is dispersed. For example, the blocking agent can be added to the water mixture immediately after the prepolymer is dispersed. Optionally at least one polymeric component (g) (MW>about 500), with at least three or more primary and/or secondary amino groups per mole of the polymer, is added to the water medium after the prepolymer is dispersed and the blocking agent is added.

Examples of suitable mono-functional dialkylamine blocking agents (e) include: N,N-diethylamine, N-ethyl-N-propylamine, N,N-diisopropylamine, N-tert-butyl-N-methylamine, N-tert-butyl-N-benzylamine, N,N-dicyclohexylamine, N-ethyl-N-isopropylamine, N-tert-butyl-N-isopropylamine, N-isopropyl-N-cyclohexylamine, N-ethyl-N-cyclohexylamine, N,N-diethanolamine, and 2,2,6,6-tetramethylpiperidine. The molar ratio of the amine blocking agent to the isocyanate groups of the prepolymer prior to dispersion in water generally should range from about 0.05 to about 0.50, for example from about 0.20 to about 0.40. Catalysts may be used for the de-blocking reactions.

Examples of the suitable polymeric component (g) include: polyethylenamine, poly(vinylamine), poly(allylamine), and poly(amidoamine) dendrimers.

Other additives that may be optionally included in the aqueous dispersion or in the prepolymer include: anti-oxidants, UV stabilizers, colorants, pigments, crosslinking agents, phase change materials (i.e., Outlast®, commercially available from Outlast Technologies, Boulder, Colo.), antimicrobials, minerals (i.e., copper), microencapsulated well-being additives (i.e., aloe vera, vitamin E gel, aloe vera, sea kelp, nicotine, caffeine, scents or aromas), nanoparticles (i.e., silica or carbon), calcium carbonate, flame retardants, antitack additives, chlorine degradation resistant additives, vitamins, medicines, fragrances, electrically conductive additives, and/or dye-assist agents (i.e., Methacrol®, commercially available from E.I. DuPont de Nemours, Wilmington, Del.). Other additives which may be added to the prepolymer or the aqueous dispersion comprise adhesion promoters, anti-static agents, anti-cratering agents, anti-crawling agents, optical brighteners, coalescing agents, electroconductive additives, luminescent additives, flow and leveling agents, freeze-thaw stabilizers, lubricants, organic and inorganic fillers, preservatives, texturizing agents, thermochromic additives, insect repellants, and wetting agents.

Such optional additives may be added to the aqueous dispersion before, during, or after the prepolymer is dispersed, as the process allows. No organic solvent is added to the aqueous dispersion at any time.

Polyurethane aqueous dispersions falling within the scope of the present invention should be expected to have a solids content of from about 10% to about 50% by weight, for example from about 30% to about 45% by weight. The viscosity of polyurethane aqueous dispersions falling within the scope of the present invention may be varied in a broad range from about 10 centipoises to about 100,000 centipoises depending on the processing and application requirements. For example, in one embodiment, the viscosity is in the range of about 500 centipoises to about 30,000 centipoises. The viscosity may be varied by using an appropriate amount of thickening agent, such as from about 0 to about 2.0 wt %, based on the total weight of the aqueous dispersion.

An organic solvent may also be used in the preparation of films and dispersions of some embodiments. The organic solvent may be used to lower the prepolymer viscosity through dissolution and dilution and/or to assist the dispersion of solid particles of the diol compound having a carboxylic acid group such as 2,2-dimethylopropionic acid (DMPA) to enhance the dispersion quality. It may also serve for the purposes to improve the film uniformity such as reducing streaks and cracks in the coating process.

The solvents selected for these purposes are substantially or completely non-reactive to isocyanate groups, stable in water, and have a good solubilizing ability for DMPA, the formed salt of DMPA and triethylamine, and the prepolymer. Examples of suitable solvents include N-methylpyrrolidone, N-ethylpyrrolidone, dipropylene glycol dimethyl ether, propylene glycol n-butyl ether acetate, N,N-dimethylacetamide, N,N-dimethylformamide, 2-propanone(acetone) and 2-butanone(methylethylketone or MEK).

The amount of solvent added to the films/dispersion of some embodiments may vary. When a solvent is include, suitable ranges of solvent include amounts of less than 50% by weight of the dispersion. Smaller amounts may also be used such as less than 20% by weight of the dispersion, less than 10% by weight of the dispersion, less than 5% by weight of the dispersion and less than 3% by weight of the dispersion.

There are many ways to incorporate the organic solvent into the dispersion at different stages of the manufacturing process, for example,
1) The solvent can be added to and mixed with the prepolymer after the polymerization is completed prior to transferring and dispersing the prepolymer, the diluted prepolymer containing the carboxylic acid groups in the backbone and isocyanate groups at the chain ends is neutralized and chain extended while it is dispersed in water.
2) The solvent can be added and mixed with other ingredients such as Terathane® 1800, DMPA and Lupranate® MI to make a prepolymer in the solution, and then this prepolymer containing the carboxylic acid groups in the backbone and isocyanate groups at the chain ends in the solution is dispersed in water and at the same time it is neutralized and chain extended.
3) The solvent can be added with the neutralized salt of DMPA and Triethylamine (TEA), and mixed with Terathane® 1800 and Lupranate® MI to make the prepolymer prior to dispersion.
4) The s solvent can be mixed with TEA, and then added to the formed prepolymer prior to dispersion.
5) The solvent can be added and mixed with the glycol, followed by the addition of DMPA, TEA and then Lupranate® MI in sequence to a neutralized prepolymer in solution prior to dispersion.

The aqueous polyurethane dispersions of the some embodiments are particularly suitable for adhesive shaped articles, which can be used for fabric bonding, lamination, and adhesion purposes when applied with heat and pressure for a relatively short period of time. Pressures, can for example, range from about atmospheric pressure to about 60 psi and times can range from less than about one second to about 30 minutes in accordance with the bonding method used.

Such shaped articles may be made by coating the dispersion onto a release paper and drying to remove water at temperatures below about 100° C. through commercially available processes to form a film on the paper. The formed film sheets can be slit into strips of desired width and wound-up into spools for later use in applications to form stretch articles, for example textile fabrics. Examples of such applications include: stitch-less or seamless garment constructions; seam seal and reinforcement; labels and patches bonding to garments; and localized stretch/recovery enhancement. The adhesion bonding can be developed in the temperature range of from about 100° C. to about 200° C., such as from about 130° C. to about 200° C., for example, from about 140° C. to about 180° C., in a period of 0.1 seconds to several minutes, for example, less than about one minute. Typical bonding machines are Sew Free (commercially available from SewSystems in Leicester, England), Macpi hemming machine (commercially available from the Macpi Group in Brescia, Italy), Framis hot air welding machine (commercially available from Framis Italy, s p.a. in Milano, Italy). This bonding is expected to be strong and durable when exposed to repeated wear, wash, and stretch in a textile fabric garment.

The coating, dispersion, or shaped article may be pigmented or colored and also may be used as a design element in that regard.

In addition, articles with laminated films or dispersions can be molded. For example, fabric can be molded under conditions appropriate for the hard yarn in the fabric. Also, molding may be possible at temperature which will mold the shaped article or dispersion, but below temperatures suitable for molding the hard yarn.

Lamination can be carried out to secure the shaped article to a fabric using any method wherein heat is applied to the laminate surface. Methods of heat application include, for example, ultrasonic, direct heat, indirect heat, and microwave. Such direct lamination may provide an advantage in view of other methods used in the art in that the shaped article may not only bond to the a substrate via a mechanical interaction but also via a chemical bond. For example, if the substrate has any reactive hydrogen functional groups, such groups may react with the isocyanate and hydroxyl groups on the dispersion or shaped article, thereby providing a chemical bond between the substrate and the dispersion or shaped article. Such chemical bonding of the dispersion or shaped article to the substrate can give a much stronger bond. Such bonding may occur in dry shaped articles that are cured onto a substrate or in wet dispersions that are dried and cured in one step. Materials without an active hydrogen include polypropylene fabrics and anything with a fluoropolymer or a silicone based surface. Materials with an active hydrogen include, for example, nylon, cotton, polyester, wool, silk, cellulosics, acetates, metals, and acrylics. Additionally, articles treated with acid, plasma, or another form of etching may have active hydrogens for adhesion. Dye molecules also may have active hydrogens for bonding.

Methods and means for applying the polyurethaneurea compositions of some embodiments include, but are not limited to: roll coating (including reverse roll coating); use of a metal tool or knife blade (for example, pouring a dispersion onto a substrate and then casting the dispersion into uniform thickness by spreading it across the substrate using a metal tool, such as a knife blade); spraying (for example, using a pump spray bottle); dipping; painting; printing; stamping; and impregnating the article. These methods can be used to apply the dispersion directly onto a substrate without the need of further adhesive materials and can be repeated if additional/heavier layers are required. The dispersions can be applied to any fabrics of knits, wovens or nonwovens made from synthetic, natural, or synthetic/natural blended materials for coating, bonding, lamination and adhesion purposes. The water in the dispersion can be eliminated with drying during the processing (for example, via air drying or use of an oven), leaving the precipitated and coalesced polyurethane layer on the fabrics to form an adhesive bond.

At least one coagulant may optionally be used to control or to minimize penetration of dispersions according to the invention into a fabric or other article. Examples of coagulants that may be used include calcium nitrate (including calcium nitrate tetrahydrate), calcium chloride, aluminum sulfate (hydrated), magnesium acetate, zinc chloride (hydrated) and zinc nitrate.

An example of a tool that can be used for applying dispersions is a knife blade. The knife blade can be made of metal or any other suitable material. The knife blade can have a gap of a predetermined width and thickness. The gap may range in thickness, for example, from 0.2 mils to 50 mils, such as a thickness of 5 mils, 10 mils, 15 mils, 25 mils, 30 mils, or 45 mils.

The thickness of the films, solutions, and dispersions may vary depending on the application. In the case of dry shaped articles, the final thickness may, for example, range from about 0.1 mil to about 250 mil, such as from about 0.5 mil to about 25 mil, including from about 1 to about 6 mil (one mil=one thousandth of an inch).

Suitable thicknesses include about 0.5 mil to about 12 mil, about 0.5 to about 10 mil, and about 1.5 mil to about 9 mil. For aqueous dispersions, the amount used may, for example, range from about 2.5 g/m² to about 6.40 kg/m², such as from about 12.7 to about 635 g/m², including from about 25.4 to about 152.4 g/m².

Types of planar sheets and tapes that can be coated with dispersions and shaped articles falling within the scope of the present invention include, but are not limited to: textile fabrics, including wovens and knits; nonwovens; leather (real or synthetic); paper; metal; plastic; and scrim.

End articles that can be produced using the dispersions and shaped articles falling within the scope of the present invention include, but are not limited to: apparel, which includes any type of garment or article of clothing; knitted gloves; upholstery; hair accessories; bed sheets; carpet and carpet backing; conveyor belts; medical applications, such as stretch bandages; personal care items, including incontinence and feminine hygiene products; and footwear. Articles coated with dispersion or covered with film or tape may be used as sound suppression articles.

Non-elastic fabrics laminated to shaped articles can have improved stretch and recovery and improved molding properties.

Articles comprising shaped articles, film, tape, or aqueous polyurethane dispersion may be molded. The articles may be made with multiple layers of substrate and shaped article, film, tape, or dispersion. The multi-layered articles also may be molded. Molded and non-molded articles may have different levels of stretch and recovery. The molded articles may comprise a body shaping or body supporting garment, such as a brassiere.

Examples of apparel or garments that can be produced using the dispersions and shaped articles falling within the scope of the present invention, include but are not limited to: undergarments, brassieres, panties, lingerie, swimwear, shapers, camisoles, hosiery, sleepwear, aprons, wetsuits, ties, scrubs, space suits, uniforms, hats, garters, sweatbands, belts, activewear, outerwear, rainwear, cold-weather jackets, pants, shirtings, dresses, blouses, mens and womens tops, sweaters, corsets, vests, knickers, socks, knee highs, dresses, blouses, aprons, tuxedos, bisht, abaya, hijab, jilbab, thoub, burka, cape, costumes, diving suit, kilt, kimono, jerseys, gowns, protective clothing, sari, sarong, skirts, spats, stole, suits, straitjacket, toga, tights, towel, uniform, veils, wetsuit, medical compression garments, bandages, suit interlinings, waistbands, and all components therein.

Methods for performing and overcoming common problems in reverse roll coating are described in Walter, et al., “Solving common coating flaws in Reverse Roll Coating,” AIMCAL Fall Technical Conference (Oct. 26-29, 2003), the entire disclosure of which is incorporated herein by reference.

Another aspect of the invention is an article comprising the shaped article and a substrate wherein the shaped article and the substrate are attached to form a laminate whereby coefficient of friction of the elastic laminate is greater than that of the substrate alone. Examples of this are a waistband with a coating or film comprising the aqueous polyurethane dispersion which prevents slippage of the garment from another garment such as a blouse or shirt, or alternately prevents slippage of the waistband on the skin of the garment wearer.

Shaped article, for example films of the aqueous polyurethaneurea dispersions, may have the following properties:
set after elongation of from about 0 to 10%, for example from about 0 to 5%, typically from about 0 to about 3%,
elongation of about 400 to about 800%, and
tenacity of about 0.5 to about 3 Mpa.

Laminates prepared from articles and substrates may have the following properties:
peel strength after 50 washes wherein at least 50% of the strength is maintained from the same before washing,
air permeability of at least about 0 to about 0.5 cfm, and
moisture vapor permeability of at least about 0 to about 300 g/m2 over 24 h.

### Analytical Methods

In the examples that follow, the following analytical methods were used:

### Peel Strength for Adhesive Bonds

ASTM D903-93, the entire disclosure of which is incorporated herein by reference, was modified for testing of film laminated fabrics. The sample size used for testing was 1 inches×6 inches (2.5 cm×15 cm). The separation rate was 2 inches per minute (5 centimeter per minute). Data are reported as pounds of force per inch of sample width (kilogram per millimeter), as shown in Tables 2 and 4.

### Wash Test

AATCC test method 150-2001, the entire disclosure of which is incorporated herein by reference, was used for the washing of molded bra cups. The machine cycle was (I) normal/cotton sturdy. The washing temp was (III) 41° C. The drying procedure was (A)(i) tumble cotton sturdy 66° C. for 30 minutes with a 10 minute cool down time.

### Moisture Vapor Transport

ASTM E96-00, the entire disclosure of which is incorporated herein by reference, was used for testing the moisture vapor transport properties of articles. Data are reported as grams per square meter for a 24 hour period, as shown in Table 7.

### Air Permeability

ASTM D-737, the entire disclosure of which is incorporated herein by reference, was used for testing the air permeability properties of articles. Data are reported as cubic feet of air per minute per square foot of fabric (elm, cubic centimeter of air per second per square centimeter of fabric (ccs)), as shown in Table 7.

### Elongation, Tenacity, and Set

Elongation and tenacity properties were measured on films using a dynamic tensile tester Instron. The sample size was 1×3 inches (1.5 cm×7.6 cm) measured along the long dimension. The sample was placed in clamps and extended at a strain rate of 200% elongation per minute until a maximum elongation was reached. The tenacity and elongation were measured just prior to the film break. Similarly, the set % was measured by extending a 1×3 inches sample of film (1.5 cm×7.6 cm) from 0 to 50% elongation for five cycles at a strain rate of 200% per minute. The set % was measured after the fifth cycle.

### EXAMPLES

Terathane® 1800 is a linear polytetramethylene ether glycol (PTMEG), with a number average molecular weight of 1,800 (commercially available from INVISTA S.a. r.L., of Wichita, Kans.);

Pluracol® HP 4000D is a linear, primary hydroxyl terminated polypropylene ether glycol, with a number average molecular weight of 400 (commercially available from BASF, Brussels, Belgium);

Mondur® ML is an isomer mixture of diphenylmethane diisocyanate (MDI) containing 50-60% 2,4′-MDI isomer and 50-40% 4,4′-MDI isomer (commercially available from Bayer, Baytown, Tex.);

Lupranate® MI is an isomer mixture of diphenylmethane diisocyanate (MDI) containing 45-55% 2,4′-MDI isomer and 55-45% 4,4′-MDI isomer (commercially available from BASF, Wyandotte, Mich.);

Isonate® 125MDR is a pure mixture of diphenylmethane diisocyanate (MDI) containing 98% 4,4′-MDI isomer and 2% 2,4′-MDI isomer (commercially available from the Dow Company, Midland, Mich.); and

DMPA is 2,2-dimethylopropionic acid.

The following prepolymer samples were prepared with MDI isomer mixtures, such as Lupranate® MI and Mondur® ML, containing a high level of 2,4′-MDI.

### Example 1

The preparation of the prepolymers was conducted in a glove box with nitrogen atmosphere. A 2000 ml Pyrex® glass reaction kettle, which was equipped with an air pressure driven stirrer, a heating mantle, and a thermocouple temperature measurement, was charged with about 382.5 grams of Terathane® 1800 glycol and about 12.5 grams of DMPA. This mixture was heated to about 50° C. with stirring, followed by the addition of about 105 grams of Lupranate® MI diisocyanate. The reaction mixture was then heated to about 90° C. with continuous stirring and held at about 90° C. for about 120 minutes, after which time the reaction was completed, as the % NCO of the mixture declined to a stable value, matching the calculated value (% NCO aim of 1.914) of the prepolymer with isocyanate end groups. The viscosity of the prepolymer was determined in accordance with the general method of ASTM D1343-69 using a Model DV-8 Falling Ball Viscometer (sold by Duratech Corp., Waynesboro, Va.) operated at about 40° C. The total isocyanate moiety content, in terms of the weight percent of NCO groups, of the capped glycol prepolymer was measured by the method of S. Siggia, “Quantitative Organic Analysis via Functional Group”, 3rd Edition, Wiley & Sons, New York, pp. 559-561 (1963), the entire disclosure of which is incorporated herein by reference.

### Example 2

The solvent-free prepolymer, as prepared according to the procedures and composition described in Example 1, was used to make the polyurethaneurea aqueous dispersion of the present invention.

A 2,000 ml stainless steel beaker was charged with about 700 grams of de-ionized water, about 15 grams of sodium dodecylbenzenesulfonate (SDBS), and about 10 grams of triethylamine (TEA). This mixture was then cooled with ice/water to about 5° C. and mixed with a high shear laboratory mixer with rotor/stator mix head (Ross, Model 100LC) at about 5,000 rpm for about 30 seconds. The viscous prepolymer, prepared in the manner as Example 1 and contained in a metal tubular cylinder, was added to the bottom of the mix head in the aqueous solution through flexible tubing with applied air pressure. The temperature of the prepolymer was maintained between about 50° C. and about 70° C. The extruded prepolymer stream was dispersed and chain-extended with water under the continuous mixing of about 5,000 rpm. In a period of about 50 minutes, a total amount of about 540 grams of prepolymer was introduced and dispersed in water. Immediately after the prepolymer was added and dispersed, the dispersed mixture was charged with about 2 grams of Additive 65 (commercially available from Dow Corning®, Midland Mich.) and about 6 grams of diethylamine (DEA). The reaction mixture was then mixed for about another 30 minutes. The resulting solvent-free aqueous dispersion was milky white and stable. The viscosity of the dispersion was adjusted with the addition and mixing of Hauthane HA thickening agent 900 (commercially available from Hauthway, Lynn, Mass.) at a level of about 2.0 wt % of the aqueous dispersion. The viscous dispersion was then filtered through a 40 micron Bendix metal mesh filter and stored at room temperatures for film casting or lamination uses. The dispersion had solids level of 43% and a viscosity of about 25,000 centipoises. The cast film from this dispersion was soft, tacky, and elastomeric.

### Example 3

The preparation procedures were the same as Example 2, except that DEA was not added into the dispersion after the prepolymer was mixed. Initially, the dispersion appeared to be no different from Example 2. However, when the dispersion was aged at room temperatures for one week or more, the film cast from this dispersion was brittle and not suitable for adhesions or laminations.

### Example 4

Several multi-layer articles were tested for air permeability according to the ASTM testing method described above; the results are shown in the following table.

Air Permeability

| | | | Air | Mold t/T |
|---|---|---|---|---|
| | | | Permeability | (sec/C) |
| Substrate | Film | Coverage | (cubic ft/min.) | P = 3.5 bar |
| Foam | None | | 45.70 | 120/185 |
| Foam | 3 mil^{a} | Full | 23.83 | 120/185 |
| Foam | Bemis 2 mil 3410^{b} | Full | 14.80 | 120/185 |
| Foam | Polyurethaneurea | Narrow | 1.39 | 120/185 |
| | solution^{c} | | | |
| Foam | 3 mil^{a} perforated | Full | 34.97 | 120/185 |
| Fabric | None | | 368.67 | 45/185 |
| Fabric | 3 mil^{a} | Full | 54.53 | 45/185 |
| Fabric | Bennis 2 mil 3410^{b} | Full | 43.57 | 45/185 |
| Fabric | Polyurethaneurea | Narrow | 2.97 | 45/185 |
| | solution^{c} | | | |
| Fabric | 3 mil^{a} | Full | 138.67 | 45/185 |

^{a}The inventive film of example 3
^{b}Commercially available from Bemis Associates Inc., Shirley, MA
^{c}Polyurethaneurea spinning solution with DMAc obtained from a commercial spandex plant

The testing results show that films of the inventive polyurethaneurea dispersion provide greater air permeability as compared to commercially available thermoplastic polyurethane films and films cast from a polyurethaneurea solution.

While the present invention has been described in an illustrative manner, it should be understood that the terminology used is intended to be in a nature of words or description rather than of limitation. Furthermore, while the present invention has been described in terms of several illustrative embodiments, it is to be appreciated that those skilled in the art will readily apply these teachings to other possible variations of the invention.

What is claimed is:

1. An article comprising multiple layers comprising:
(a) at least two layers; and
(b) at least one polyurethaneurea film, applied or laminated or bonded to an apparel fabric; wherein said film is cast from an aqueous polyurethaneurea dispersion that is substantially organic solvent free; and wherein said dispersion comprises % NCO of about 1.8 to about 2.6, and further wherein said dispersion comprises a prepolymer comprising
(i) at least one polyol selected from polyethers, polyesters, polycarbonates, and combinations thereof, wherein the polyol has a number average molecular weight of 600 to 3500;
(ii) a polyisocyanate; and
(iii) at least one diol compound.

2. The article of claim 1, wherein the film is between the at least two layers.

3. The article of claim 1, wherein said at least two layers are selected from the group consisting of (a) two fabric layers, (b) two foam layers, (c) a fabric layer and a foam layer, and combinations thereof.

4. The article of claim 1, wherein said at least two layers include at least two fabric layers and at least two foam layers.

5. The article of claim 4, wherein the film is adjacent to a foam layer on each side and each foam layer is adjacent to a fabric layer.

6. The article of claim 1, wherein the article is molded.

7. The article of claim 1, wherein the article is pressed.

8. The article of claim 1, wherein the film extends throughout the entire area of the multiple layer article.

9. The article of claim 1, wherein the film extends to a portion of the area of the multiple layer article.

10. The article of claim 1, wherein at least two polyurethaneurea films are included.

11. The article of claim 1, wherein said polyurethaneurea dispersion comprises a polymer having a weight average molecular weight from about 40,000 to about 150,000.

12. The article of claim 1, wherein said polyurethaneurea dispersion comprises a polymer having a weight average molecular weight from about 100,000 to about 150,000.

13. The article of claim 1, wherein said polyurethaneurea dispersion comprises a polymer having a weight average molecular weight from about 120,000 to about 140,000.

14. The article of claim 1, wherein said film is porous.

15. The article of claim 1, wherein said film is perforated.

16. The article of claim 1 in the form of a garment.

17. The article of claim 3, further comprising an adhesive between two or more layers.

18. The article of claim 17, wherein said adhesive is a hot melt adhesive, a contact adhesive, a thermoset, a thermoplastic, or a polyurethaneurea aqueous dispersion.
